(19) United States
(12) Patent Application Publication
(10) Pub. No.: US 2006/0160649 A1
(43) Pub. Date: Jul. 20, 2006

(54) Fluid pump for a transmission

(76) Inventor: John M. Seipold, Glasford, IL (US)

Correspondence Address: CATERPILLAR INC.;100 N.E. ADAMS STREET, PATENT DEPT., PEORIA, IL, 616296490, US

(21) Appl. No.: 11/274,365

(22) Filed: Nov. 15, 2005

Related U.S. Application Data
(63) Continuation-in-part of application No. 11/022,630, filed on Dec. 28, 2004.
(60) Provisional application No. 60/660,707, filed on Mar. 11, 2005.

(51) Int. Cl. F16H 31/00

(52) U.S. Cl. 475/116

(57) ABSTRACT

An input member from an engine drives a fluid pump to provide hydraulic control and lubrication to transmission components. The fluid pump is positioned between the input member and an auxiliary device, such that a common driven member provides power to the fluid pump and the auxiliary device.

### RELATED APPLICATIONS

This application claims priority to U.S. application Ser. No. 11/022,630, entitled “Rear Power Takeoff” filed on Dec. 28, 2004, to John M. Seipold and Kevin G. Meyer.

### TECHNICAL FIELD

The present invention relates to automatic transmissions and, more particularly, to charge pumps for transmitting fluid throughout the transmission.

### BACKGROUND

Transmissions typically use an internal or external pump to provide hydraulic and lubrication fluid throughout the transmission. Internal pumps maintain the fluid within the transmission, however, external pumps are much easier to service in the event of failure. The hydraulic fluid is used to actuate clutches and brakes while the lubrication fluid cools and prevents rapid wear of the transmission components. Typically, the fluid pump includes a set of bearings, a gear, or gears to drive the pump, and a rotatable member to transfer power from the engine to the pump.

For example, U.S. Pat. No. 5,279,391 to Harold R. Ward, teaches a fluid pump for a transmission. The fluid pump rests within a fluid reservoir and is driven by a gear. The gear receives power from a series of intermeshing gears and offset countershafts. The pump receives fluid from the reservoir and pumps the fluid through a filter and into the rotating components of the transmission. Typically, a power take-off device is driven off one of the countershafts.

The additional gears and shafts needed to run the pump and power take-off device increase cost and weight of the transmission.

The present invention is directed to overcoming one or more of the problems as set forth above.

### SUMMARY OF THE INVENTION

In one exemplary aspect of the present invention, a transmission for a vehicle is provided. The transmission includes a transmission housing with a front and rear portion, an input member configured to rotate about a first axis, a fluid pump drivingly connected to the input member and positioned on a second axis offset from the first axis, and an auxiliary device shaft connected to the fluid pump and extending to the rear portion of the transmission.

In another embodiment, a transmission for a vehicle includes a transmission housing with a front and rear portion, an input member configured to rotate about a first axis, and a driven assembly rotating about a second axis offset and parallel to the first axis. The driven assembly is driven by the input member. The driven assembly includes a fluid pump and a power take-off shaft connected to the fluid pump and extending to the rear portion of the transmission. The input member drives the driven assembly to simultaneously rotate the fluid pump and to rotate the power take-off shaft.

In still another exemplary embodiment, a method of simultaneously driving a fluid pump and a power take-off device on a transmission is provided. The method includes the steps providing power to an input member on a first axis of rotation and simultaneously transferring power to a fluid pump and an auxiliary device shaft connected to the fluid pump, on a second axis of rotation.

It is to be understood that both the foregoing general description and the following detailed description are exemplary and explanatory only and are not restrictive of the invention.

### BRIEF DESCRIPTION OF THE DRAWINGS

FIG. 1 is an isometric view of a transmission having a rear-mounted power take-off and hydraulic pump according to an exemplary embodiment of the present disclosure; and

FIG. 2 is a cross-sectional isometric view of a transmission and driven assembly.

### DETAILED DESCRIPTION

Reference will now be made in detail to embodiments of the invention, examples of which are illustrated in the accompanying drawings.

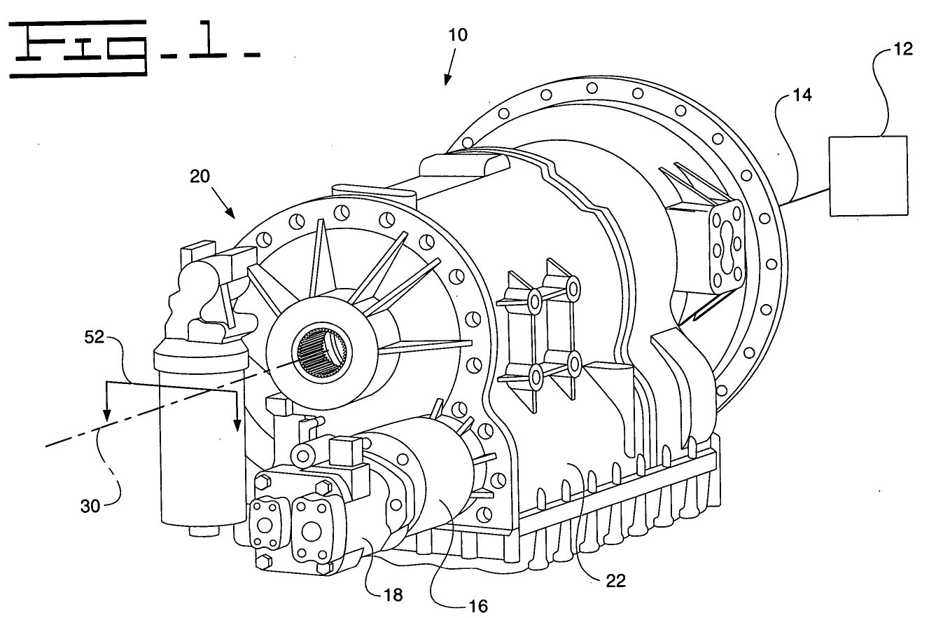

FIG. 1 illustrates a transmission 10 of an engine 12. The engine 12 may be, for example, an internal combustion engine or any other type of engine known in the art. The engine 12 and the transmission 10 may be mounted within an engine compartment of a work machine (not shown) and may be configured to supply power to elements of the work machine by any conventional means.

The transmission 10 may be connected to the engine 12 through any conventional means. In an exemplary embodiment, an input shaft, or input member 14 of the transmission 10 directly couples an output shaft of the engine 12 using, for example, a conventional torque converter (not shown).

A power take-off (“PTO”) 16 useful in supplying power to a pump assembly 18 mounts to a rear side (20) of the transmission 10, specifically to the rear side 20 of the transmission case, or housing 22. The PTO 16 operates to drive the pump assembly 18 to supply hydraulic fluid to elements (not shown) of the work machine. In one embodiment, the pumping assembly 18, rather than the PTO 16, mounts directly to the rear portion 20 of the transmission 10 with a pump adapter. In such an embodiment, the pumping mechanism operates to supply hydraulic power to elements of the work machine, whenever the transmission 10 receives power. It is recognized that any type of auxiliary device, such as the PTO, the pump, or an electric motor/generator can be attached to the transmission housing 22.

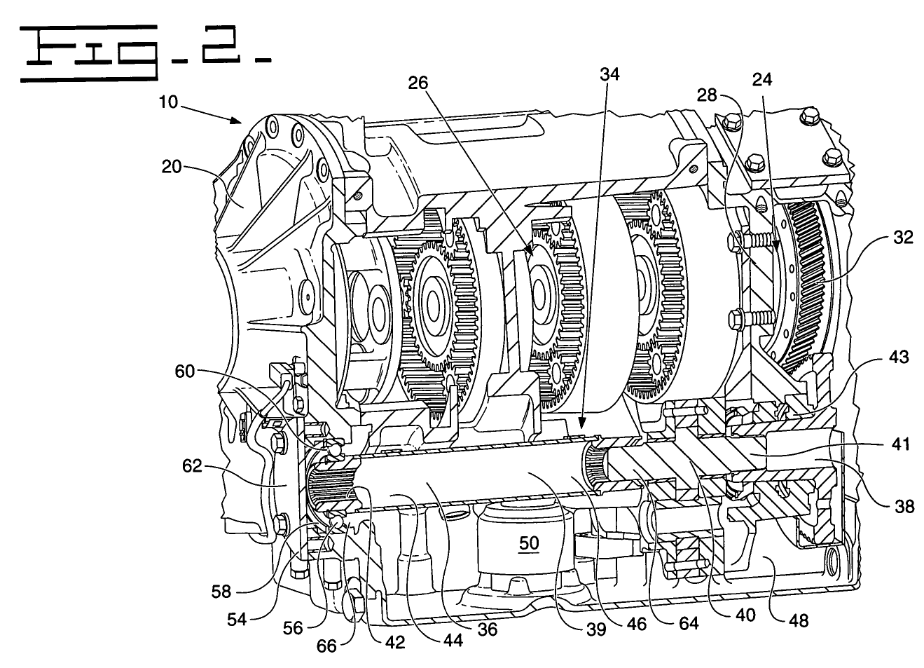

FIG. 2 illustrates a cross-sectional view of the transmission 10. The transmission 10 includes a first and second section 24 and 26 divided by a wall 28. On the first section 24 an input drive gear 32 directly couples the input shaft 14 such that the input drive gear 32 rotates at the same rotational speed as the input shaft 14 while the engine 12 is operating. The planetaries are positioned on the second section 26.

The input drive gear 32 drives a driven assembly 34 to transfer power from the engine 12 to the PTO 16. The driven assembly 34 may be a PTO drive shaft 36 connected to a driven gear 38, or alternatively, the PTO drive shaft 36 may be connected to a charge pump 40, which is driven by the driven gear 38 through a splined receiver 41. The driven assembly 34 is displaced from and parallel to a first axis 30 (See FIG. 1). The driven gear 38 rotates about a second axis 39. The PTO drive shaft 36 is configured with a spline 42, or the like, on a first end 44 to receive the PTO 16 so as to provide power thereto. Similarly, the PTO drive shaft 36 is splined on a second end 46 to connect to the charge pump 40 or the driven gear 38. The driven gear 38 passes through the wall 28 and is supported by bearings 43. The input drive gear 32 and the driven gear 38 may be sized and configured so as to drive the PTO 16 of the work machine at a desired rate. One skilled in the art will recognize that there are numerous gear ratios that can be accomplished by changing the size of the input drive gear 32 and the driven gear 38.

The transmission further includes a series of three planetary gear sets 47, clutches (not shown), brakes (not shown), and other automatic transmission components for automatic transmissions. The planetary gear sets 47 rotate about the first axis 30. The clutches and brakes function according to well-known automatic transmissions techniques.

The charge pump 40 provides hydraulic power to elements throughout the transmission 10 for lubrication and/or clutch and brake engagement. The charge pump 40 is a gear pump to draw fluid from a sump 48 through a suction line 50. One skilled in the art will recognize that various types of charge pumps 40 exist and are well known in the art. It is envisioned that any type of charge pump 40 may be used in the current described configuration. The fluid leaves the charge pump 40 at a predetermined pressure to the oil filter (not shown) and through control valves to actuate the various clutches and brakes, and to lubricate the internal transmission components.

In an exemplary embodiment of the present invention, the driven assembly 34 is disposed below the first axis 30 (See FIG. 1) of the transmission 10. In particular, the driven assembly 34 and the PTO 16 may be disposed in a lower side quadrant of the transmission 10. It is envisioned, however, that the driven assembly 34, and the PTO 16 may be positioned at any location within the transmission housing 22. It is preferable, however, that the driven assembly 34, specifically the charge pump 40, be positioned where access is facilitated. In the illustrated embodiment, the driven assembly 34 is located below a horizontal plane 52 for easy access after the oil has been drained and an oil pan removed. If the driven assembly 34 is positioned at a location above the horizontal plane, it is envisioned that access holes, compartments, or lids may be used to facilitate access thereto.

As discussed above, the PTO drive shaft 36 may be a separate shaft with respect to the driven gear 38 and the charge pump 40. Advantageously, the PTO drive shaft 36 may be an optional component. Specifically, the transmission 10 can be manufactured and sold without the optional PTO drive shaft 36. Rather than having to buy a completely new transmission, a kit may be acquired containing the optional PTO drive shaft 36, a bearing 56, and two snap rings 58 and 60. One snap ring 58 secures the bearing 56 to the transmission housing 22 and the other snap ring 60 secures the PTO drive shaft 36 to the bearing 56. The PTO 16 fastens to a flange 54 on the rear portion 20 of the transmission 10. It is noted that any kind of mounting arrangement can used for attaching the PTO 16, or other auxiliary device, to the transmission housing 22. For example, the mounting arrangement may be any kind of bolt pattern provided in the transmission housing 22, as is well known to SAE standards.

To install the PTO drive shaft 36 post sale, the customer, dealer, or mechanic simply removes a PTO cover 62, inserts the first end 44 of the PTO drive shaft 36 into the bearing 56, secures the PTO drive shaft 36 to the bearing 56 with the snap ring 60, or other fastening device, such as a bolt, screw, clamp, clip, press, or permanent structure, and slides the spline of the second end 46 of the PTO drive shaft over a splined output member 64 of the charge pump 40 or receiver 41 of the driven member 38. It is noted that the PTO drive shaft 36 may be pressed into the bearing 56. It is further noted that the act of pressing the PTO drive shaft 36 into the bearing 56 may be equivalent to securing the PTO drive shaft 36 to the bearing 56. The snap ring 56 is configured to prevent significant axial movement of the PTO drive shaft 36 with respect to the bearing 56. The bearing 56 is pressed, or installed into a transmission bearing bore 66 of the housing 22, and secured with the snap ring 58, or other fastening device, such as a bolt, screw, clamp, clip, press, or permanent structure. It is noted again that the act of pressing the bearing 56 into the transmission bearing bore may be equivalent to securing the bearing 56 to the bearing bore 66. It may be necessary to heat the bearing bore 66 before installing the bearing 56 therein. The bearing bore 66 and flange 54 define an aperture with an axis coaxially aligned with the second axis 39. It is envisioned that the bearing 56 may be secured to the PTO drive shaft 36 and subsequently inserted into the bearing bore 66 and connected to the charge pump receiver 64 or receiver 41 of the driven gear 38.

The spline 42 on the first end 44 of the PTO drive shaft 36 is configured to receive the PTO 16. It is noted that the splines 42 may be internal or external, and may be any shape.

### INDUSTRIAL APPLICABILITY

Work machines known to use automatic transmissions of the type disclosed in the present invention have tight constraints due to the large size of the engine, the large size of the transmission, distance between the frame rails, exhaust routing pipes, and heavy duty suspension and steering components. On-highway trucking applications, as well as vocational vehicles, such as dump trucks, recreational vehicles, cement mixers, and garbage trucks are typical examples of the type of vehicle typical for application of the present invention. The transmission provides power to move the vehicle and the ability to mount a power take-off device to the rear of the transmission. Positioning the PTO 16 at the rear side 20 of the transmission 10 helps eliminate the need for machine modifications.

The PTO drive shaft 36 may be sold as an optional unit to decrease overall costs for users not in need of a rear-mounted PTO. The PTO drive shaft 36 may, however, be sold and purchased and easily installed at a later date if the user determines that a need exists. Additional components such as bearings and snap rings, or other fastening devices, may be used to hold the PTO drive shaft in position.

It will be apparent to those skilled in the art that various modifications and variations can be made without departing from the scope or spirit of the invention. Other embodiments of the invention will be apparent to those skilled in the art from consideration of the specification and practice of the invention disclosed herein. It is intended that the specification and examples be considered as exemplary only.

What is claimed is:

1. A transmission for a vehicle, comprising:
a transmission housing with a front and rear portion;
an input member configured to rotate about a first axis;
a fluid pump drivingly connected to the input member and positioned on a second axis offset from the first axis; and
an auxiliary device shaft connected to the fluid pump and extending to the rear portion of the transmission.

2. The transmission according to claim 1, further comprising an input drive member and a driven member, the driven member rotatably connected to the input drive member, and wherein the driven member drives the fluid pump and, wherein the auxiliary device shaft directly connects to the fluid pump.

3. The transmission according to claim 2, wherein the driven member and second axis are located in a lower quadrant of the transmission housing, with respect to the first axis.

4. The transmission according to claim 1, wherein the ratio of engine speed to fluid pump speed remains substantially constant during operation of the engine.

5. The transmission according to claim 1, wherein the rear portion of the transmission housing includes a bearing adapted to receive the auxiliary device shaft.

6. The transmission according to claim 1, further comprising at least one planetary gear set having a sun gear, a ring gear, and carrier gears disposed between the sun gear and the ring gear, the at least one planetary gear set being driven by the input member.

7. A transmission for a vehicle, comprising:
a transmission housing with a front and rear portion;
an input member configured to rotate about a first axis;
a driven assembly rotating about a second axis offset and parallel to the first axis, the driven assembly being driven by the input member, wherein the driven assembly includes:
a fluid pump configured to pump fluid throughout the transmission; and
a power take-off shaft connected to the fluid pump and extending to the rear portion of the transmission;
wherein the input member drives the driven assembly to simultaneously rotate the fluid pump and to rotate the power take-off shaft.

8. The transmission according to claim 7, wherein the driven assembly further includes a driven gear drivingly connected to the input member, and wherein the driven gear drives the fluid pump and, wherein the power take-off shaft directly connects to the fluid pump.

9. The transmission according to claim 8, wherein the second axis is located in a lower quadrant of the transmission housing, with respect to the first axis.

10. The transmission according to claim 7, wherein the ratio of engine speed to fluid pump speed remains substantially constant during operation of the engine.

11. The transmission according to claim 7, wherein the rear portion of the transmission housing includes a bearing adapted to receive the power take-off shaft.

12. The transmission according to claim 7, further comprising at least one planetary gear set having a sun gear, a ring gear, and carrier gears disposed between the sun gear and the ring gear, the at least one planetary gear set being driven by the input member.

13. A method of simultaneously driving a fluid pump and an auxiliary device on a transmission comprising:
providing power to an input member on a first axis of rotation; and
simultaneously transferring power to a fluid pump and an auxiliary device shaft connected to the fluid pump, on a second axis of rotation.

14. The method according to claim 13, wherein the driven gear and second axis are located in a lower quadrant of the transmission housing, with respect to the first axis.

15. The method according to claim 13, wherein the ratio of engine speed to fluid pump speed remains substantially constant during operation of the engine.
